(19) United States
(12) Patent Application Publication
(10) Pub. No.: US 2005/0230246 A1
(43) Pub. Date: Oct. 20, 2005

(54) Gas sensor and methods using the same

(76) Inventors: David E. Lemaster, White Lake, MI (US); Mustafa U. Unuvar, Flint, MI (US); David P. Wallace, Flint, MI (US)

Correspondence Address: Jimmy L. Funke;Delphi Technologies, Inc., M/C 480-410-202, P.O. Box 5052, Troy, MI, 48007, US

(21) Appl. No.: 10/828,049

(22) Filed: Apr. 20, 2004

(51) Int. Cl. G01N 27/26

(52) U.S. Cl. 204/424; 204/431

(57) ABSTRACT

A gas sensor comprises a sensing element having a sensing end, wherein the sensing end is disposed with a shield; and the shield comprises a plurality of louvers, wherein the louvers are thermally actuatable to selectively open at a predetermined temperature.

### BACKGROUND

Oxygen sensors are used in a variety of applications that require qualitative and quantitative analysis of gases. In automotive applications, the direct relationship between oxygen concentration in the exhaust gas and air to fuel ratio (A/F) of the fuel mixture supplied to the engine allows the oxygen sensor to provide oxygen concentration measurements for determination of optimum combustion conditions, maximization of fuel economy, and management of exhaust emissions.

One type of sensor uses an ionically conductive solid electrolyte between porous electrodes. For oxygen sensing, solid electrolyte sensors are used to measure oxygen activity differences between an unknown gas sample and a known gas sample. In the use of a sensor for automotive exhaust, the unknown gas is exhaust and the known gas, i.e., reference gas, is usually atmospheric air because the oxygen content in air is relatively constant and readily accessible. This type of sensor is based on an electrochemical galvanic cell operating in a potentiometric mode to detect the relative amounts of oxygen present in an automobile engine's exhaust. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle includes an ionically conductive solid electrolyte material, a porous electrode with a porous protective overcoat exposed to exhaust gases (“exhaust gas electrode”), and a porous electrode exposed to a known gas partial pressure (“reference electrode”). Sensors used in automotive applications may use a yttrium stabilized zirconia based electrochemical galvanic cell with porous platinum electrodes, operating in potentiometric mode, to detect the relative amounts of a particular gas, such as oxygen for example, that is present in an automobile engine's exhaust. Also, a sensor may have a ceramic heater to help maintain the sensor's ionic conductivity. When opposite surfaces of the galvanic cell are exposed to different oxygen partial pressures, an electromotive force is developed between the electrodes on the opposite surfaces of the zirconia wall, according to the Nernst equation:

$$E = ( \frac{RT}{4 F} ) ln ( \frac{{P}_{{O}_{2}}^{ref}}{{P}_{{O}_{2}}} )$$

where:
E=electromotive force
R=universal gas constant
F=Faraday constant
T=absolute temperature of the gas
p_{O}_{₂}^{ref}=oxygen partial pressure of the reference gas
P_{O}_{₂}=oxygen partial pressure of the exhaust gas

Due to the large difference in oxygen partial pressure between fuel rich and fuel lean exhaust conditions, the electromotive force (emf) changes sharply at the stoichiometric point, giving rise to the characteristic switching behavior of these sensors. Consequently, these potentiometric oxygen sensors indicate qualitatively whether the engine is operating fuel-rich or fuel-lean, conditions without quantifying the actual air-to-fuel ratio of the exhaust mixture. Oxygen sensors measure the oxygen present in the exhaust to make the correct determination when the oxygen content (air) exactly equals the hydrocarbon content (fuel).

Oxygen sensors include a ceramic sensing element that is brought up to temperature by a heater. The use of a heater may result in a sensor tip temperature of up to about 1,000° C. making it very susceptible to thermal shock failure of the element due to water intrusion. Generally, heated oxygen sensors have been subject to internal ceramic element cracking, especially in sensors disposed down stream from the catalytic converter, induced by condensate water in the exhaust. The water is produced as a byproduct during combustion, and may condense in the exhaust system, for example in exhaust pipes, and/or converter, when the engine is shut off. Generally, the further away from the converter is from the engine the more water will condense inside the converter and inner walls of all of the exhaust areas. As a result of water being in the exhaust system, the heated sensing element may be subject to ceramic cracking when the water contacts the hot element. The sudden impact of liquid water will cause severe thermal shock and cracking of the element, causing irreparable damage to the sensor.

Various vehicle and sensor shields and other techniques have been tried to limit this problem. These include special heater control circuits and modified sensor shields. Such remedies may increase vehicle or sensor complexity, adding to cost of production. Vehicle shields have met with some success but, when incorrectly designed, have actually made the problem worse.

Accordingly, there remains a need in the art for a sensor shield that protects the sensing element for water in the exhaust system.

### SUMMARY

One embodiment a gas sensor comprises a sensing element having a sensing end, wherein the sensing end is disposed with a shield; and the shield comprises a plurality of louvers, wherein the louvers are thermally actuatable to selectively open at a predetermined temperature.

Another embodiment of a gas sensor comprises a sensing element having a sensing end, wherein the sensing end is disposed with a shield; and the shield comprises an end hole; and a thermally actuating spring lock capable of blocking the end hole at a predetermined temperature.

In one embodiment of a method of sensing an exhaust gas, the method comprises exposing a gas sensor to a gas stream, the gas sensor comprising a sensing element having a sensing end disposed with a shield comprising a plurality of louvers; heating the shield and louvers to open the louvers at predetermined temperature, wherein the predetermined temperature is a temperature sufficient for water to be in a gas phase; passing gas through the louvers to a sensing element; and sensing the gas.

In another embodiment of a method of sensing an exhaust gas, the method comprises exposing a gas sensor to a gas stream, the gas sensor comprising a sensing element having a sensing end, wherein the sensing end is disposed with a shield; and the shield comprises an end hole; and a thermally actuating spring lock capable of blocking the end hole at a predetermined temperature; heating spring lock to a relaxed state temperature sufficient to unblock the end hole, wherein the predetermined temperature is a temperature sufficient for water to be in a gas phase; passing gas through the end hole to the sensing element; and sensing the gas.

The above-described and other features will be appreciated and understood by those skilled in the art from the following detailed description, drawings, and appended claims.

### DRAWINGS

Referring now to the figures, which are exemplary embodiments, and wherein the like elements are numbered alike:

FIG. 1 is an exploded view of a planar gas sensor element.

FIG. 2 is a cross-sectional view of a gas sensor.

FIG. 3 is an enlarged prospective view of a gas sensor shield including variable louvers.

FIG. 4 is an enlarged prospective view of a gas sensor shield including horizontally disposed slots.

FIG. 5 is an enlarged prospective view of a gas sensor shield system including a spring lock shown in a blocking state, an outer shield, and an inner shield.

FIG. 6 is an enlarged prospective view of a gas sensor shield system including a spring lock shown in a relaxed state, an outer shield, and an inner shield.

FIG. 7 is an enlarged prospective view of an outer shield.

FIG. 8 is an enlarged prospective view of an inner shield.

FIG. 9 is an enlarged top view of an embodiment of a spring lock.

FIG. 10 is an enlarged prospective view of a single shield comprising a spring lock illustrated in a blocking state.

FIG. 11 is an enlarged prospective view of another embodiment of a single shield comprising a spring lock illustrated in a blocking state.

FIG. 12 is a schematic drawing illustrating thermal expansion effects in a slot disposed on a gas sensor shield.

### DETAILED DESCRIPTION

Although described in connection with an oxygen sensor, it is to be understood that the sensor could be a nitrogen oxide sensor, hydrogen sensor, hydrocarbon sensor, temperature sensor, or the like. Furthermore, while oxygen is the reference gas used in the description disclosed herein, it should be understood that other gases could be employed as a reference gas. It is also understood that various sensor geometries are also feasible (e.g., planar and conical) as well as multiple cell sensors. It should further be noted that the terms “first,” “second,” and the like herein do not denote any order or importance, but rather are used to distinguish one element from another, and the terms “a” and “an” herein do not denote a limitation of quantity, but rather denote the presence of at least one of the referenced item. It is also noted that the terms “bottom” and “top” are used herein, unless otherwise noted, merely for convenience of description, and are not limited to any one position or spatial orientation.

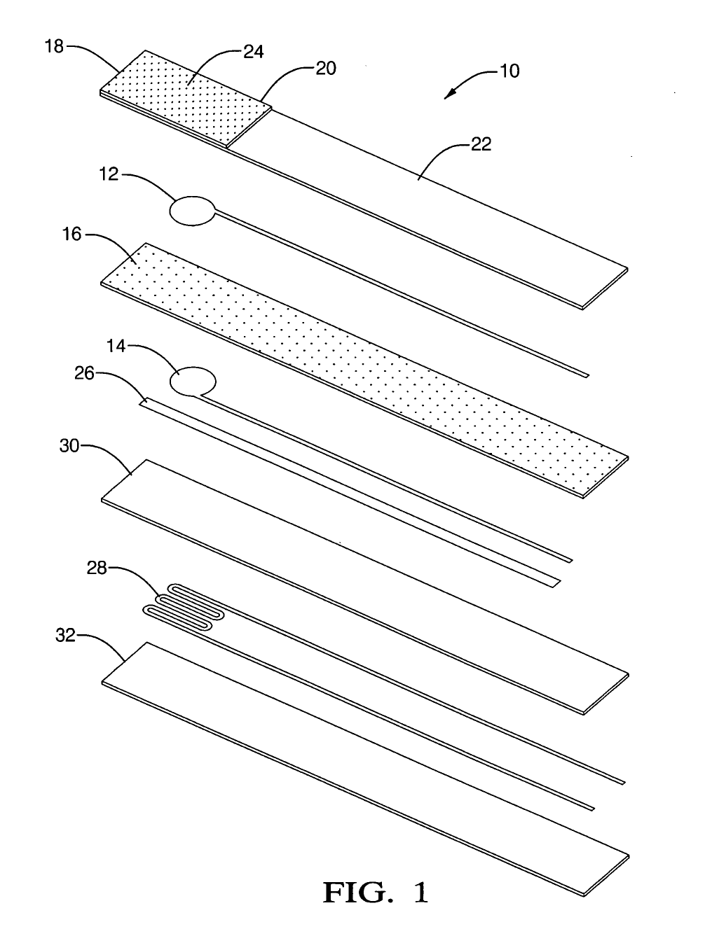

Referring to FIG. 1, an exemplary planar gas sensor element 10 is illustrated. The sensing (i.e., first, exhaust gas or outer) electrode 12 and the reference gas (i.e., second or inner) electrode 14 are disposed on opposite sides of, and adjacent to, an electrolyte layer 16 creating an electrochemical cell (12/16/14). On the side of the sensing electrode 12, opposite solid electrolyte 16, is a protective layer 18 that enables fluid communication between the sensing electrode 12 and the exhaust gas. This protective layer 18 may optionally comprise a porous portion 20 disposed adjacent the sensing electrode 12 and a solid portion 22. Disposed over at least a portion of the protective layer 18, adjacent the sensing electrode 12 is a protective coating 24.

Meanwhile, disposed on the side of the reference electrode 14, opposite solid electrolyte 16, can be an optional reference gas channel 26, which is in fluid communication with the reference electrode 14 and optionally with the ambient atmosphere and/or the exhaust gas. Disposed on a side of the reference gas channel 26, opposite the reference electrode 14 may optionally be a heater 28 for maintaining sensor element 10 at a desired operating temperature. Disposed between the reference gas channel 26 and the heater 28, as well as on a side of the heater opposite the reference gas channel 26, can be one or more insulating layers 30, 32.

The electrolyte 16, which may be a solid electrolyte, can be formed of a material that is capable of permitting the electrochemical transfer of oxygen ions while inhibiting the passage of exhaust gases. Possible electrolyte materials include zirconium oxide (zirconia), cerium oxide (ceria), calcium oxide, yttrium oxide (yttria), lanthanum oxide, magnesium oxide, and the like, as well as combinations comprising at least one of the foregoing electrolyte materials, such as yttria doped zirconia, and the like.

Disposed adjacent to electrolyte 16 are electrodes 12, 14. The sensing electrode 12, which is exposed to the exhaust gas during operation, preferably has a porosity sufficient to permit diffusion to oxygen molecules therethrough. Similarly, the reference electrode 14, which can be exposed to a reference gas such as oxygen, air, or the like, during operation, preferably has a porosity sufficient to permit diffusion to oxygen molecules therethrough. These electrodes can comprise a metal capable of ionizing oxygen, including, but not limited to, platinum, palladium, gold, osmium, rhodium, iridium and ruthenium; and metal oxides, such as zirconia, yttria, ceria, calcium oxide, aluminum oxide (alumina), and the like; as well as combinations comprising at least one of the foregoing metals and metal oxides. Other additives such as zirconia may be added to impart beneficial properties such as inhibiting sintering of the platinum to maintain porosity.

Protective layer 18 disposed on the side of the sensing electrode 12, opposite solid electrolyte 16, is designed to allow the electrodes (12, 14) to sense the particular gas without inhibiting the performance of the sensor element 10. Possible materials for the protective layer 18, include alumina, (such as, delta alumina, gamma alumina, theta alumina, and the like, and combinations comprising at least one of the foregoing aluminas), as well as other dielectric materials.

Heater 28 can be employed to maintain the sensor element at the desired operating temperature. Heater 28 can be a heater capable of maintaining the end of the sensor adjacent the electrodes at a sufficient temperature to facilitate the various electrochemical reactions therein, with a preferred operating temperature of about 650° C. to about 800° C., and an operating temperature of about 700° C. to about 750° C. more preferred. Heater 28, which can comprise, for example, platinum, aluminum, palladium, and the like, as well as mixtures, oxides, and alloys comprising at least one of the foregoing metals can be screen printed or otherwise disposed onto a substrate (e.g., insulating layers 30, 32), to a thickness of about 5 micrometers to about 50 micrometers, with about 10 micrometers to about 40 micrometers more preferred.

Optional insulating layers 30, 32 provide structural integrity (e.g., protect various portions of the sensor element from abrasion and/or vibration, and the like, and provide physical strength to the sensor), and physically separate and electrically isolate various components. The insulating layer(s) can each be up to about 200 micrometers thick, with a thickness of about 50 micrometers to about 200 micrometers preferred. The insulating layers 30, 32 can comprise a dielectric material such as delta alumina, gamma alumina, theta alumina, and combinations comprising at least one of the foregoing aluminas, and the like.

In addition to the above sensor components, other sensor components can be employed, including but not limited to, lead gettering layer(s), leads, contact pads, ground plane, ground plane layers(s), support layer(s), additional electrochemical cell(s), and the like. The leads, which supply current to the heater and electrodes, are often formed on the same layers as the heater and the electrodes to which they are in electrical communication and extend from the heater/electrode to the terminal end of the sensor where they are in electrical communication with the corresponding via (not shown) and appropriate contact pads (not shown).

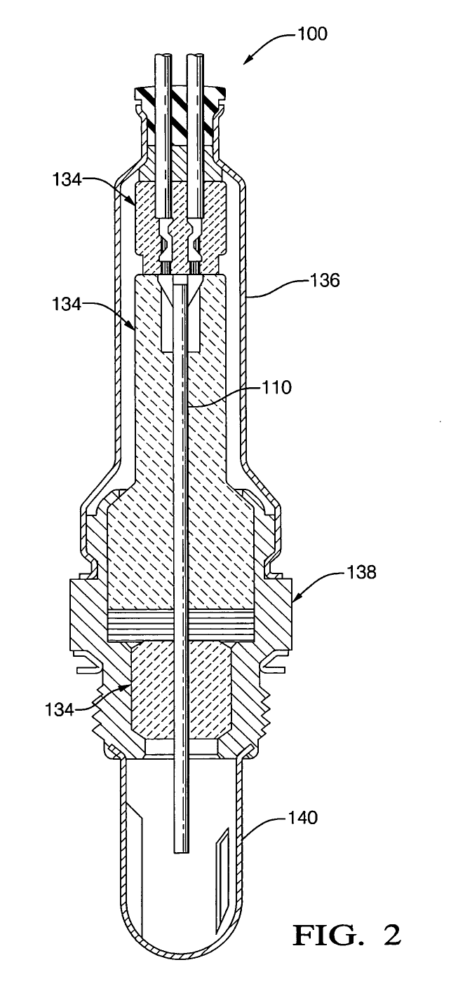

Referring now to FIG. 2, a gas sensor generally designated 100 is shown. Gas sensor 100 comprises gas sensor element 110. It is understood by those skilled in the art that any shape may be used for gas sensor element 110, including conical, tubular, rectangular, and flat, and the like, and the various components, therefore, will have complementary shapes, such as in plan views, circular, oval, quadrilateral, rectangular, or polygonal, among others. Gas sensor element 110 is embedded in an insulator 134, which is covered by an upper shell 136. Upper shell 136 is connected to lower shell 138. Gas sensor 100 comprises an outer shield 140, which is connected to lower shell 138.

The outer shield 140 is designed with thermally actuatable louvers that remain closed at a first temperature and are open at a second temperature. For example, the outer shield 140 has louvers that are closed at temperatures where water is in a non-gaseous phase, i.e. temperatures less than or equal to about 100° C. In other words, the louvers are closed at temperatures, for example, where condensate in an exhaust system, if contacted with the heated sensor element (e.g. 110), may cause thermal shock to the sensor element. Conversely, the louvers are open at temperatures of greater than or equal to about 130° C., when water is in a gas phase. It is noted that the louvers may be in a transitional phase at temperatures of 100° C. to 130° C. As will be discussed in much greater detail, outer shield 140 is used to protect sensing element 110 from water in the exhaust system, which can cause thermal shock during start-up conditions.

Several combinations of oxygen sensors are discussed hereunder with reference to individual drawing figures. One of skill in the art will easily recognize that many of the components of each of the embodiments are similar or identical to the others. For example, geometries of a shield (e.g., 240) illustrated in one embodiment may also be employed in other embodiments. It is noted that distinct structure is discussed relative to each figure/embodiments. Additionally, materials listed in discussing an embodiment may be used in other embodiments, unless stated otherwise.

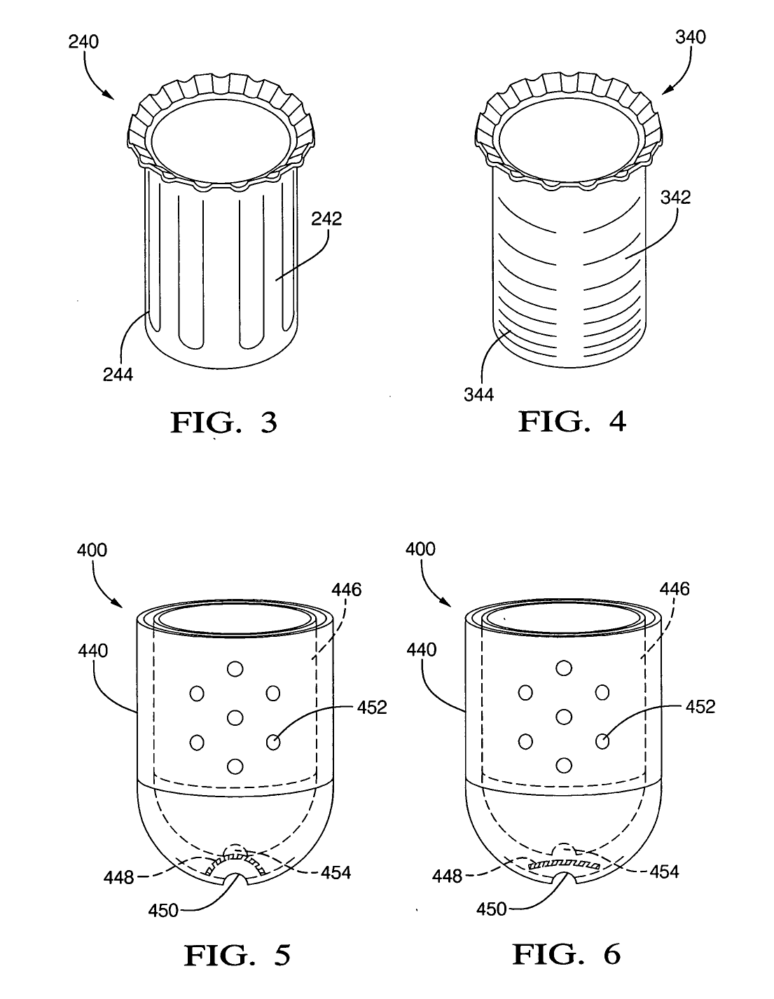

Referring now to FIG. 3, an exemplary shield 240 comprising a plurality of variable louvers 242 is illustrated. In this example, an array of generally longitudinal slots 244 are located in the sides of shield 240 forming variable louvers 242. It is noted that in varying embodiments the slots may be horizontal, as illustrated in FIG. 4, diagonal, and the like. The array of generally longitudinal slots may be equally disposed along the surface of shield 240. In one embodiment, variable louvers 242 may comprise a bimetallic material, which allows variable louvers 242 to open (i.e., expand or bend) when exhaust gas are beyond the thermal concern due to water in the exhaust system, e.g., when temperatures are greater than or equal to about 130° C., and close when the exhaust gas is less than or equal to about 100° C. to protect the sensing element (e.g., sensing element 110 shown in FIG. 2) from water in the exhaust system. In other words, variable louvers selectively open at a predetermined temperature to control exhaust gas flow into shield 240. The term “bimetallic” refers to a metal composition comprising two metals that are layered.

An example of a bimetallic metal is a metal composition comprising palladium and sterling silver, wherein the composition comprises about 12.5 wt. % palladium and about 87.5wt. % sterling silver, based on the total weight of the composition. In this example, the melting point of the composition is that of silver, i.e., 802° C. It is noted that in exhaust gases that exceed a temperature of about 802° C. a different material may be used, e.g., materials having a melting point that is greater than the temperature of the exhaust gas. For example, the bimetallic metal used for variable louvers 242 may be capable of withstanding operating temperatures of greater than or equal to about 1,000° C. Generally, the operating temperatures are less than or equal to about 1,000° C., with temperatures less than or equal to about 800° C. typical. In making the bimetallic metal, the metals are paired based on the thermal properties of the metals. The metals may then be bonded by any method suitable to produce the bimetallic metal. For example, paired metals may be bonded under a vacuum of greater than or equal to about 13 kPa and a temperature greater than or equal to about 800° C. It is noted that the temperatures and pressures may vary with the materials to be bonded.

Since bimetallic metals comprise two metals, heat may cause the bimetallic metal to bend as a result of the differences in thermal expansion coefficients. It is noted that bending occurs towards the side of the metal with the lower coefficient of expansion. The bending displacement of a material may be calculated and represented mathematically by the following equation.

$$A = \frac{{α}_{b} {L}^{2} Δ t}{s}$$

Where A=bending displacement of material; L=length of material; S=thickness of material (e.g., a shell thickness of about 0.5 millimeters to about 1 millimeter); Δt=temperature difference (i.e., t₂−t₁), where to is a first temperature (e.g., a temperature at which bending starts) and t₂ is a second temperature greater than the first temperature; α_{b}=“specific thermal bending”, wherein α_{b} is unique for various materials. However, it is noted that the specific thermal bending, α_{b}, may be estimated to be about 14×10⁻⁶/K for most metals. However, one of skill in the art may readily solve the above equation to calculated the specific thermal bending assuming the other variables can be measured, e.g., bending displacement of the material.

Referring now to FIG. 4, a shield 340 comprises an array of generally horizontal slots 344. In this example, the slots 344 forming louvers 342 are cut closer at a bottom portion (tip portion) of shield 340 than at a top portion (portion closes to lower shell), this allows more exhaust on the active tip of the element. It is noted that shield 340 and more particularly, the louvers 342 may comprise a bimetallic metal as discussed above. Similarly, when the exhaust is greater than 130° C. the louvers 342 will expand opening slots 344 to allow more exhaust to enter through the slots 344. When the sensor cools, louvers 344 contract and prevent water vapor from entering (e.g., a temperatures less than or equal to about 100° C.).

In another embodiment, the shield (e.g. 240, 340) may comprise a material that has a high expansion coefficient (e.g., greater than or equal to about 16×10⁶/° C.) and a high melting point (e.g., greater than or equal to about 800° C., with greater than or equal to about 1,000° C. preferred). Materials that may be used for shield 340 include, but are not limited to, those listed in Table 1, as well as a material comprising titanium, silicon, germanium, and mixtures comprising at least one of the foregoing. For example, the material may have the formula Ti₅Si₅Ge_{1.5}. While the metals listed in Table 1 may be paired with other metals to obtain a bimetallic metal as discussed above, in various embodiments, the shield (e.g., 240, 340) does not comprise a bimetallic metal. In other words, the shield may employ a material having an expansion coefficient greater than or equal to about 16×10⁻⁶/° C. and a high melting point (e.g., greater than or equal to about 1,000° C.).

TABLE 1

| Composition | | Thermo exp. | |
|---|---|---|---|
| (wt. % based on total | | Coefficient/ | Melting |
| weight of total | | deg. C. | Point (deg. |
| composition) | Name | (×10⁻⁶) | C.) |
| 97.6 wt. % Cu, 1.4 wt % | Tin-Silicon | 17.9 | 1,041 |
| Sn, 1.0 wt. % Si | Bronze | | |
| 65 wt. % Cu, 18 wt. % | Nickel silver | 18.36 | 1,110 |
| Ni, 17 wt. % Zn | 18% A | | |
| 99.90 wt. % Cu, | Deoxidized | 17.71 | 1,082 |
| 0.01 wt. % P | copper | | |
| 95.5 wt. % Cu, 4.3 wt. % | Phosphor bronze | 18.9 | 1,050 |
| Sn, 0.2 wt %. P | 30 | | |
| 89 wt. % Cu, 9 wt. % | Hardware bronze | 18.18 | 1,050 |
| Zn, 2 wt. % Pb | | | |
| 85 wt. % Cu, 15 wt. % | Red brass | 18.72 | 1,030 |
| Zn | | | |
| 70-5 wt. % Fe, | Allegheny metal | 17.3 | 1,430-1,470 |
| 17-20 wt. % | | | |
| Cr, 7-10 wt. % | | | |
| Ni, 0.5 wt. % Mn, | | | |
| ≦0.05 wt. % | | | |
| Si, 0.2 wt. % C | | | |

It is noted that the materials listed in Table 1 are merely examples of materials that may have expansion coefficient greater than or equal to about 16×10⁻⁶/° C. and high melting point (e.g., greater than or equal to about 1,000° C.).

Advantageously, the mechanical thermal expansion protects the sensing element without using algorithms to calculate the water in the exhaust pipe before the heater is turned on. In other words, a self-regulating water shield in the exhaust system is obtained. Although an oxygen sensor may be placed anywhere along the exhaust flow path, an oxygen sensor including a self-regulating water shield may be especially beneficial in a post location of the exhaust gases, i.e., in a location where the sensor monitors the catalytic converter efficiency.

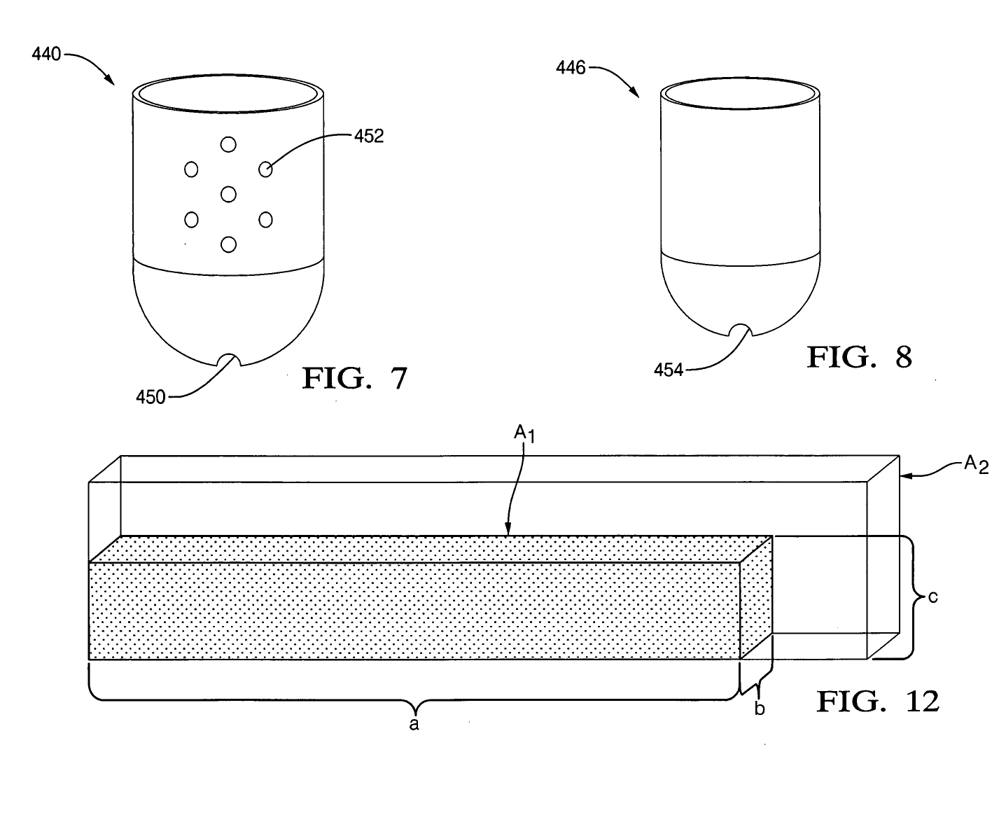

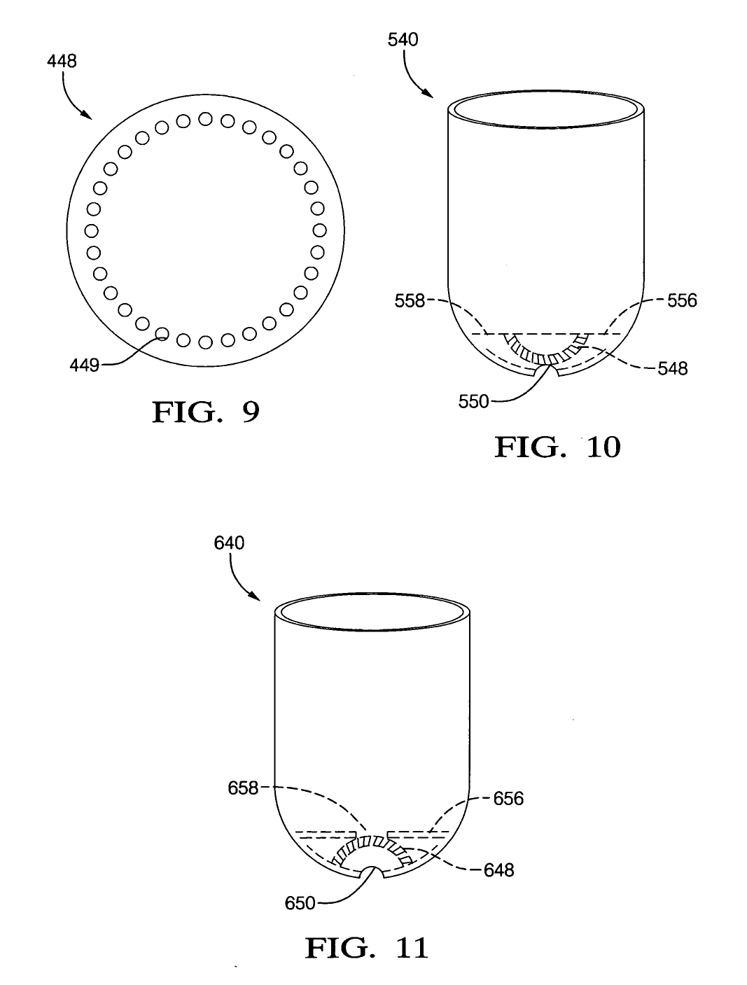

In yet another embodiment, illustrated in FIG. 5, a shield system generally designated 400 comprises an outer shield 440 (shown also in FIG. 7 for clarity) and an inner shield 446 (shown also in FIG. 8 for clarity), and as will be discussed in much greater detail, a spring lock 448 (embodiment shown in FIG. 9 for clarity). Outer shield 440 is attached to inner shield 446 via crimping, welding, and the like. Outer shield 440 comprises an outer end hole 450 and an array of side holes 452, which have a pattern that allows the entrance of exhaust gas in between the two shields. Inner shield 446 comprises an inner end hole 454. Depending on the position of spring lock 448, incoming flow is allowed to reach the sensing element (e.g., 110) through inner end-hole 454 of inner shield 446. As illustrated in FIG. 5, the spring lock 448 is in a blocking state. In this state, water is allowed to enter in between outer shield 440 and inner shield 446. By blocking the inner end hole 454, the water may be prevented from contacting the sensing element that is located inside the inner shield 446. However, during this blocking state, the spring design allows water to reach the outer end hole 450 of the outer shield 440, thereby allowing the water to escape into the exhaust stream.

FIG. 6 illustrates shield system 400 in a relaxed state. FIG. 6 differs from FIG. 5 only in the position (state) of spring lock 448. As illustrated, when spring lock 448 in a relaxed state, it no longer blocks inner end hole 454 allowing exhaust gases to reach the sensing element.

In operation, during start-up conditions, exhaust gases may flow through outer end hole 450 in outer shield 440, continue through holes 449 in spring lock 448 (FIG. 9) to reach the outer shield 440, thereby exiting back into the exhaust stream. In embodiments where the spring lock 448 has holes, the spring lock preferably has holes disposed along the periphery, such that a portion of the spring lock 448 that is in physical contact with inner end hole 454 is capable of blocking inner end hole 454 at temperatures less than or equal to about 100° C. In other embodiments, the spring lock 448 may be non-forminated (without holes).

In an initial or cold (blocking) position, spring lock 448 is in the up position blocking inner end hole 454, hence blocking water from reaching the sensing element. Spring lock 448 remains in the up position until the temperature of the exhaust gases is greater than or equal to about 130° C., which is achieved in seconds. It is at or around this point where the spring lock 448 relaxes to allow exhaust gases to flow in through the inner end hole 454 for operation of the sensor. As the exhaust stream conditions reach the operating temperature and pressure, condensed water is completely cleared out of the exhaust system eliminating risk of failure due to thermal shock of the sensing element.

Furthermore, in the initial blocking mode, spring lock 448 has an upwardly curved shape causing interference and allowing it to fasten itself in between outer shield 440 and inner shield 450. In the relaxed mode, however, spring lock 448 flattens and pulls away from inner shield 450 to a position where its outer diameter reaches its largest dimension and fastening itself onto a small containment lip inside the outer shield the outer shield. In both positions, it is intended that the spring lock 448 fastens itself between the outer shield 440 and inner shield 446 in the blocking mode or on the containment lip (not shown) of the inner shield during relaxed mode to further improve its high temperature vibration characteristics. Preferably, the spring lock 448 comprises a geometry complementary to the geometry of the shield(s). For example, in an embodiment the spring lock 448 comprises a disc-like geometry.

The amount of curvature (upward movement) created in blocking mode and the threshold temperature where spring lock 448 reaches the desired flatness to allow penetration of exhaust gases into inner shield 446 may be controlled by selection and mating of materials. For example, spring lock 448 may comprise a bimetallic material. The bimetallic material is created by using the mismatch material properties of two metals and by bonding the metals in a way that one material shrinks and expands at a higher rate and amount than the other bi-metal. This mismatch and designed geometry allows the deformation of spring lock 448. In other words, spring lock 448 may be designed based on the desired application. For example, a slow moving design allows spring lock 448 to gradually pull away from inner end-hole 454 of the inner shield 446. Or a sudden moving combination, spring lock 448 allows for a move suddenly at a pre-determined threshold temperature. Nevertheless, in all applications, the maximum operating temperature conditions are considered for selection of all metals. Some examples of suitable materials may include a material selected from those listed in Table 1.

In yet other embodiments, a spring lock may be used with a non-dual shield design (FIGS. 10-11), i.e., a single shield design. For example, a shield generally designated 540 is illustrated in FIG. 10. The shield comprises a spring lock 548, and end hole 550, an inner plate 556 comprising a plurality of plate holes 558. It should be noted that the shield is illustrate in blocking mode. During blocking mode, the spring lock 548 blocks end hole 550 at temperatures where water is in a non-gaseous state, e.g., temperatures less than or equal to about 100° C., similar to those methods discussed above. During the relaxed mode, the spring lock 548 may fasten itself to a containment lip, thereby holding itself in place. In such an embodiment, the spring lock 548 preferably has holes (e.g., 449) to allow the passage of gases therethrough during a relaxed mode of operation (e.g., a temperatures greater than or equal to 130° C.).

Another embodiment of a single shield design is illustrated in FIG. 11. A shield general designated 640 comprises a spring lock 648, and end hole 650, an inner plate 656 comprising a plate hole 658. It should be noted that the shield is illustrate in blocking mode. In other words, the spring lock 648 may be designed to bend/flex towards end hole 650 or towards plate hole 658. Furthermore, it is noted that other embodiments employing a thermally actuating spring lock are envisioned to fall within the scope of this disclosure.

### EXAMPLES

In this example, the increase in a slot area of a shield was studied as a function of linear expansion. More particularly, red brass metal was the metal used in the shield.

Referring now to FIG. 12, a slot is illustrated having a length “a”, width thickness “b”, a width “c”, and an area A₁. In this example, “a” was 15 mm long, “b” was 3 mm, and “c” was 0.48 mm. The area was found using the formula A₁=2(ab+ac+bc). A second area, A₂, i.e., the area after thermal expansion was calculated using the following formula:
A₂=A₁[1+2α(t₂−t₁)]
where α is the coefficient of linear expansion, t, is a first temperature (e.g., a temperature at which expansion occurs) and t₂ is a second temperature greater than the first temperature. It is noted that the coefficient of linear expansion is material specific. Some coefficients of linear expansion have previously been calculated and may readily be found in engineering literature. Moreover, a coefficient of linear expansion may readily be calculated from the above equation assuming the other variables are measurable.

Based on the calculation using red brass metals at 1,000° C. the width of 0.3 mm opened up to 0.89 mm. Further, at 600° C., the width of 0.3 mm opened up to 0.5 mm.

The design of the shield, as well as the method of designing the shield can be applied to any sensor design where the sensor contacts a sensing gas. Advantageously, by employing the present design, degradation due to water entering the sensor is eliminated, thereby extending the life of the sensor. The sensors disclosed herein employ thermally actuating materials in a sensor shield to protect a sensor element a temperatures when condensate is in the system. As noted above, condensate can cause thermal shock to a heated sensing element, which can lead to sensor failure. In one embodiment, thermally actuating louvers open at temperatures beyond the concern for thermal shock, e.g., when water is in the gaseous state. In other embodiments, a thermally actuating spring can block an end hole of a shield to protect a heated sensing element, as described throughout this disclosure. Accordingly, these designs may be used to extent the useful life of a gas sensor by reducing the possibility of thermal shock to a sensor element.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A gas sensor comprising:
a sensing element having a sensing end, wherein the sensing end is disposed with a shield; and
the shield comprises a plurality of louvers, wherein the louvers are thermally actuatable to selectively open at a predetermined temperature.

2. The gas sensor of claim 1, wherein the predetermined temperature is a temperature sufficient for water to be in a gas phase.

3. The gas sensor of claim 1, wherein the predetermined temperature is greater than or equal to about 130° C.

4. The gas sensor of claim 1, wherein the shield comprises a material having a thermal expansion coefficient greater than or equal to about 16×10⁻⁶/° C. and a melting temperature greater than or equal to about 800° C.

5. The gas sensor of claim 4, wherein the melting temperature is greater than or equal to 1,000° C.

6. The gas sensor of claim 4, wherein the material comprises titanium, silicon, and germanium.

7. The gas sensor of claim 6, wherein the material is defined by the following formula Ti₅Si₅Ge_{1.5}.

8. The gas sensor of claim 1, the louvers comprise a bimetallic material.

9. The gas sensor of claim 8, wherein the bimetallic material comprises palladium and sterling silver.

10. A method of sensing an exhaust gas, comprising:
exposing a gas sensor to a gas stream, the gas sensor comprising a sensing element having a sensing end disposed with a shield comprising a plurality of louvers;
heating the shield and louvers to open the louvers at predetermined temperature, wherein the predetermined temperature is a temperature sufficient for water to be in a gas phase;
passing gas through the louvers to a sensing element; and
sensing the gas.

11. The method of claim 10, further comprising determining a concentration of at least one component of the gas.

12. A gas sensor comprising:
a sensing element having a sensing end, wherein the sensing end is disposed with a shield; and
the shield comprises an end hole; and
a thermally actuating spring lock capable of blocking the end hole at a predetermined temperature.

13. The gas sensor of claim 12, further comprising an inner shield disposed in physical communication with the shield, wherein the inner shield comprises an inner end hole.

14. The gas sensor of claim 13, wherein the spring lock is disposed between the shield and the inner shield.

15. The gas sensor of claim 12, wherein the shield comprises a plurality of side holes.

16. The gas sensor of claim 12, wherein the predetermined temperature is a temperature sufficient for water to be in a liquid phase.

17. The gas sensor of claim 16, wherein the temperature is less than or equal to about 100° C.

18. The gas sensor of claim 12, wherein the spring lock comprises a bimetallic material.

19. The gas sensor of claim 18, wherein the bimetallic material comprises palladium and sterling silver.

20. The gas sensor of claim 12, wherein the spring lock comprises a metal having a thermal expansion coefficient greater than 16×10⁻⁶/° C. and a melting temperature greater than about 800° C.

21. A method of sensing an exhaust gas, comprising:
exposing a gas sensor to a gas stream, the gas sensor comprising a sensing element having a sensing end, wherein the sensing end is disposed with a shield; and
the shield comprises an end hole; and a thermally actuating spring lock capable of blocking the end hole at a predetermined temperature;
heating spring lock to a relaxed state temperature sufficient to unblock the end hole, wherein the predetermined temperature is a temperature sufficient for water to be in a gas phase;
passing gas through the end hole to the sensing element; and
sensing the gas.
